(19) United States
(12) Patent Application Publication
(10) Pub. No.: US 2001/0043886 A1
(43) Pub. Date: Nov. 22, 2001

(54) Multi-channel quantitative control valve apparatus

(76) Inventors: Han-Oh Park, Chungbuk (KR); Hanee Park, Chungbuk (KR); Nam-Sun Kwon, Chungbuk (KR)

Correspondence Address: FOLEY & LARDNER, Washington Harbour, 3000 K Street, N.W., Suite 500, Washington, DC, 20007-5109, US

(21) Appl. No.: 09/816,783

(22) Filed: Mar. 26, 2001

(30) Foreign Application Priority Data
Mar. 24, 2000 (KR) 10-2000-0015206
Sep. 23, 2000 (KR) 10-2000-0055968

(51) Int. Cl. B01L 11/00

(52) U.S. Cl. 422/103; 422/100

(57) ABSTRACT

The present invention relates to a multi-channel quantitative control valve apparatus which controls transfer of various kinds of solutions, selectively and quantitatively. More particularly, the present invention relates to a multi-channel quantitative control valve apparatus which comprises multichannel membrane valves which control selective transfer of solutions, numerous syringes which imbibe or discharge quantitatively the selected solution, and numerous liquid flow passages.

### TECHNICAL FIELD OF THE INVENTION

The present invention relates to a multi-channel quantitative control valve apparatus which controls transfer of various kinds of solutions, selectively and quantitatively. More particularly, the present invention relates to a multi-channel quantitative control valve apparatus which comprises multi-channel membrane valves which control selective transfer of solutions, numerous syringes which imbibe or discharge quantitatively the selected solution, and numerous liquid flow passages.

### BACKGROUND ART

Various equipments used in laboratories, chemical factories or waste management facilities, require an apparatus which controls transfer of various kinds of liquids, selectively, sequentially and quantitatively.

Particularly, various research works involving isolation and purification of nucleic acids from various biological samples, are required for the recent studies of genome, blood tests, plant seed inspection, agricultural product tests, microbiological environmental tests etc.

An isolation and purification process of nucleic acids that is inevitable for DNA sequence analysis, gene amplification, gene cloning process etc., is, however, time-consuming, very laborious because it requires repetitive injections and isolations of various kinds of solutions or samples. Furthermore, an operator's skill substantially influence on the amount of nucleic acid obtained from the nucleic acid purification process.

In order to overcome these problems, an automatic nucleic acid purification apparatus has been under development. Such an automatic nucleic acid purification apparatus requires a multi-channel quantitative control valve apparatus that are capable of sequentially selecting various samples and solutions containing nucleic acid, and of transferring them accurately and quantitatively.

However, conventional rotary type multi-channel valves cannot precisely control the amount of solutions to an extent of 1 μl range due to leakage of solutions at the contact point of each liquid flow passage, and formation of liquid droplet at the end of an outlet. For these reasons, the rotary type multi-channel valves cannot be used in an automatic nucleic acid purification apparatus that requires sequential selection and quantitative transfer of various kinds of solutions.

Therefore, the development of valve apparatus that can control sequential, selective and quantitative transfer of various kinds of solutions, has been desired for a long time. Particularly, there has been a strong demand for a multi-channel quantitative control valve apparatus that can be used in an automatic nucleic acid purification apparatus recently in this field.

### SUMMARY OF THE INVENTION

The object of the present invention is to provide a multi-channel quantitative control valve apparatus, which comprises:

multi-channel membrane valves which control selective transfer of various liquids;

syringes which imbibe or discharge the selected liquids quantitatively;

liquid flow passages which connect said valves and syringes; and

a stepping motor which drives a piston of said syringes.

A multi-channel membrane valve apparatus of the invention comprises one or more bodies which form jointly:

more than one liquid flow passages;

more than one inner spaces which connect said liquid flow passages;

one or more membranes which are inserted into said inner spaces; and

an air flow passage connected with said inner spaces.

The liquid flow passages are for transferring solution. The air flow passages are passages through which air pressure is applied in order to operate membranes. Each channel comprises the first control valve 1, the second control valve 2 and the third control valve 3; the first air flow passage 10, the second flow passage 20 and the third air flow passage 21 through which air pressure is applied in order to operate these control valves; an inlet 30; an outlet 70 and a syringe connector 51 connected with the membrane valve through the liquid flow passages.

The membrane inserted in the said inner space, is a conventional membrane manufactured using sheets, films, or laminates thereof made of conventional polymeric materials that exhibit durability, chemical resistance, elasticity, flexibility, etc., such as fluorine resin, silicone resin and various kinds of rubber or synthetic resin. These membranes are inserted in the said inner space, and open or close the liquid flow passage depending on air pressure applied through said air flow passages.

The syringe 50 is connected to the body of the membrane valve through the syringe connector 51 of each channel, and imbibes or discharges solutions quantitatively, driven by the stepping motor linked to a syringe piston 52.

### BRIEF DESCRIPTION OF THE DRAWINGS

The object and other advantages of the present invention will become more apparent by describing in detail a preferred embodiment thereof with reference to the attached drawings, in which:

FIG. 1 is a cross-sectional view of a body of the membrane valve of the present invention.

FIG. 2 is a front view of a multi-channel valve apparatus of the present invention.

FIG. 3 is a front view of a multi-channel membrane valve apparatus of the present invention.

FIG. 4 is a plane view of a multi-channel membrane valve of the present invention

FIG. 5 is an disassembled perspective view of a multi-channel membrane valve of the present invention

FIG. 6 is a plane view and a side-sectional view of the second block of the blocks that constitute the multi-channel membrane valve of the present invention.

### BEST MODE FOR CARRYING OUT THE INVENTION

Hereinafter, the present invention will be described in more detail with reference to the accompanying drawings.

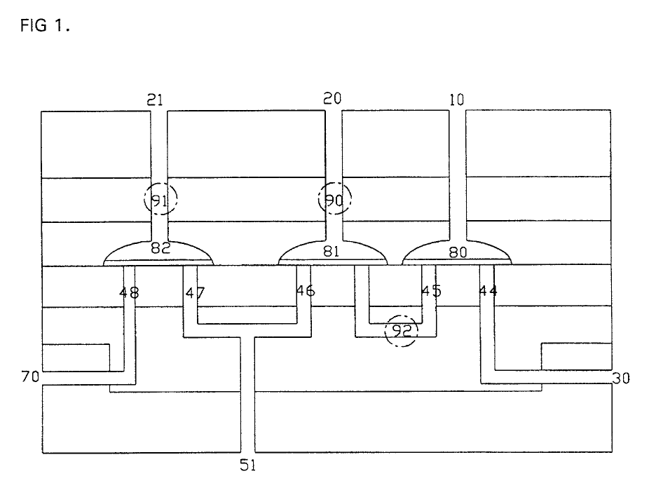

FIG. 1 is a cross sectional view of a body of membrane valve apparatus of the present invention.

The body of the membrane valve apparatus comprises five (5) liquid flow passages 44 to 48 and three (3) inner spaces 80 to 82 connected to the said liquid flow passages. Membranes are inserted in said inner spaces 80 to 82. When air pressure is applied to membranes through an air flow passage, transfer of solutions is blocked by closing the liquid flow passages in the lower part of the inner spaces 80 to 82 by said membrane. Upon releasing the applied air pressure, the restoration of membranes allows solutions to transfer by opening liquid flow passages connected to the inner spaces.

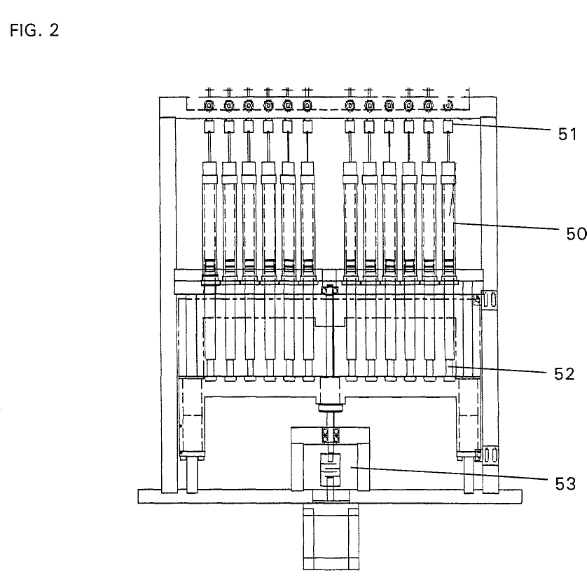

FIG. 2 is a front view of the multi-channel quantitative control valve apparatus of the present invention, which comprises a multi-channel membrane valve and numerous syringes.

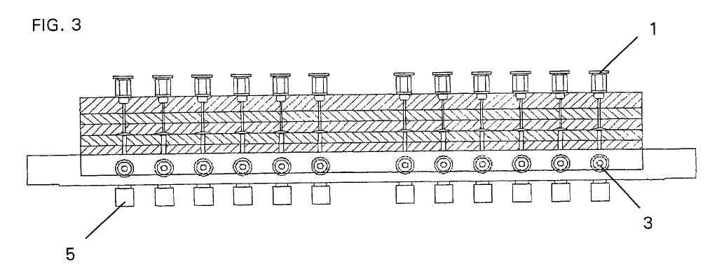

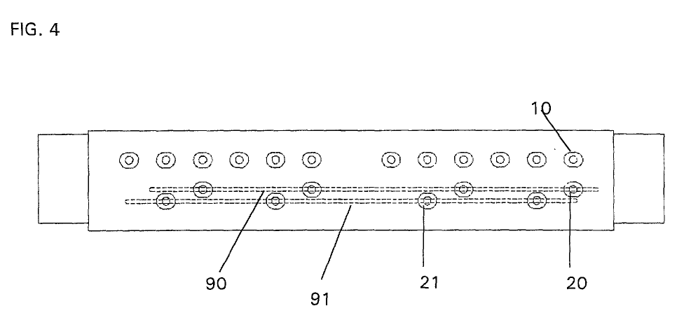

FIG. 3 is a front view of the multi-channel membrane valve apparatus of the present invention. FIG. 4 is a plane view of the multichannel membrane valve apparatus of the present invention. FIG. 3 and FIG. 4 illustrate one embodiment of the multi-channel membrane valve consisting of twelve (12) channels of the present invention. As illustrated in FIG. 3 and FIG. 4, each channel comprises an air flow passage 10 through which air pressure is applied to control opening and closing of the liquid flow passage between the inlet and the syringe; an air flow passage 20 through which air pressure is applied to control closing or opening the liquid flow passage between the syringes; and an air flow passage 21 through which air pressure is applied to control closing and opening the liquid flow passage between the syringe and the outlet.

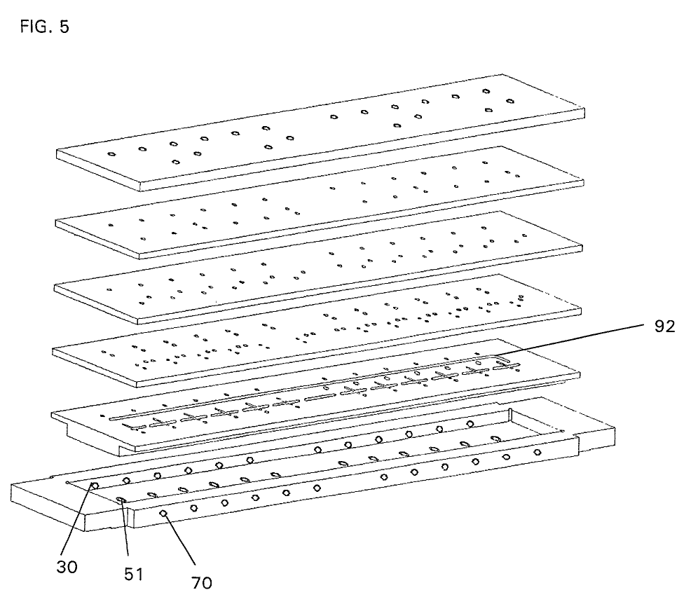

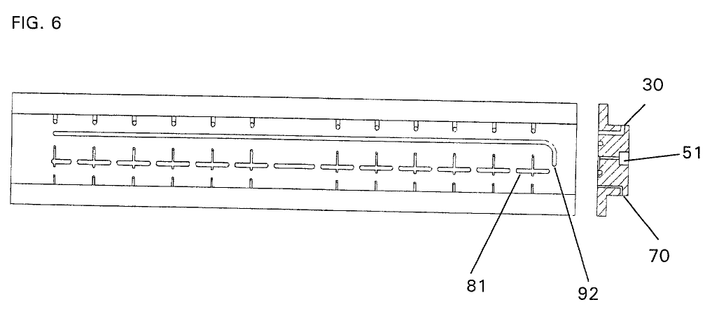

As illustrated in FIG. 5, the body of the multi-channel membrane valve of the present invention comprises combination of several blocks. FIG. 6 is a plane view and a side sectional-view of the second block of blocks that constitute the multi-channel membrane valve of the present invention. FIG. 5 and FIG. 6 illustrate one embodiment of the multichannel membrane valve of the present invention consisting of twelve (12) channels.

As illustrated in FIG. 4, in one embodiment of the multi-channel membrane valve of the present invention, the second air flow passage 20 may be connected to the second air flow connecting passage 90 through which six (6) channels are linked together, and thus opening or closing of the second control valve of each channel is controlled simultaneously by means of one time pressurization operation. The third air flow passages 21 are also connected through the third air flow connecting passages 91 to control opening and closing the third control valve of each channel simultaneously by means of one time pressurization operation, as like the second air flow passage 20. The said second connecting passage and the third connecting passage are optional components for the multi-channel quantitative control valve apparatus of the present invention.

As illustrated in FIG. 6, liquid flow passages connected to the inlet of each channel, may also be connected with each other through the liquid flow connecting passage 92 via the first control valve. This liquid flow connecting passage 92 is optionally comprised in the multi-channel quantitative control valve apparatus of the present invention.

Hereinafter, the process for selection and transfer of the solution sequentially and quantitatively by using the multi-channel membrane valve apparatus of the present invention, will be explained. However, the followings only explains the functions of the multi-channel quantitative control valve apparatus of the present invention, are not intended to be limiting the apparatus of the present invention in any manner.

Each channel of the membrane valve apparatus of the present invention comprises the first control valve, the second control valve and the third control valve.

The first control valve comprises an inlet 30, the first air flow passage 10, the first inner space 80, a liquid flow passage 44 which connects the first inner space with the inlet, a liquid flow passage 45 which connects the first inner space with the second control valve, and a membrane inserted at the first inner space.

The second control valve comprises a syringe connector 51, the second air flow passage 20, the second inner space 81, a liquid flow passage 46 which connects the second inner space with a syringe, a liquid flow passage 45 which connects the second inner space with the first control valve, and a membrane inserted at the second inner space.

The third control valve comprises a outlet 70, the third air flow passage 21, the third inner space 82, a liquid flow passage 48 which connects the third inner space with an outlet, a liquid flow passage 47 which connects the third inner space with a syringe, and a membrane inserted at the third inner space.

Optionally, the liquid flow connecting passage 45 which connects the first inner space 80 of each channel with the second control valve, is connected through the liquid flow connecting passage 92. Also, the second air flow passage 20 is connected with each other through the second connecting passage 90, and the third air flow passage 21 is connected with each other through the third connecting passage 91.

Upon opening of the first control valve 1, the solution is supplied through the inlet 30 and the liquid flow passage. At this time, the second control valve 2 is closed and thus, the solution can not imbibed into the syringe. Upon opening of the second control valve 2 and the closing the first valve 1, the solution is imbibed quantitatively into the syringe by piston action which is driven by motor. Said solutions which have been imbibed quantitatively into the syringe, are discharged toward the outlet by piston action which is driven by motor through the third control valve, and does not flow backward toward the inlet due to the closing of the second control valve.

In case of supplying various solutions different from each other through each inlet of each channel and of transferring a specific solution selected from the said various solutions, only the first control valve of the channel through which the specific solution is supplied, is opened, and the first control valves of the other channels through which other solutions are supplied should be closed. The solution supplied through the first control valve of the specific channel, is supplied to all channels through the second control valve and the liquid flow connecting passage, and is imbibed quantitatively into the syringe of each channel. Then, the first control valve and the second control valve are closed, the third control valve is opened and the syringe is operated to discharge the selected solution quantitatively through the outlet of the each channel.

As explained above, since the first control valve functions to select the solution to be transferred selectively from the various solutions, the first control valve of each channel should be opened and closed independently. However, since the second control valve functions to provide the specific solution imbibed through the first control valve with the syringes of all channels, and to prevent the solution from flowing backward toward the inlet upon discharging of the solution from the syringe, the second control valves of each channel do not need to be operated independently. The second air flow passage 20 that operate the membranes of the second control valve of each channel, is connected with each other through the second connecting passage 90. Therefore, it is preferable that the second control valves of all channels are operated by action of air pressure applied through one of the second air flow passage. Thus, and the second air flow passage doesn't need to be established in every channel. In general, it is preferable that one (1) or three (3) second air flow passage are established in every six (6) channels.

Also, the third control valves of all channels that function to transfer solutions which are discharged from the syringes into the outlet, are opened or closed simultaneously. Therefore, the third air flow passages are connected to each other through the third air flow connecting passage in order to open all of the third control valves of each channel by action of air pressure applied through any one of the third air flow passages. It is desirable that one (1) to three (3) second air flow passages are established in every six (6) channels.

### Industrial Applicability

The multi-channel quantitative control valve apparatus of the present invention may be employed to select the specific solution from various kinds of solutions, and to transfer solutions thus selected, simultaneously and quantitatively.

In the multi-channel quantitative control valve apparatus of the present invention, the solution are transferred by action of pulse generated from membrane operation and thereby, cannot form liquid droplet at the end of the outlets. Therefore, the valve apparatus of the present invention, can overcome the problem of the conventional rotary-type multi-channel valves that form liquid droplet at the end of the outlets. In addition, since the leakage of the solution at the junction point of each liquid flow passage is diminished, error in amount of the solution transferred is minimized.

Consequently, the multi-channel quantitative control valve apparatus of the present invention can be used for the process which should transfer various kinds of solution sequentially, selectively and quantitatively, such as an automatic nucleic acid purification process.

While the present invention has been particularly shown and described with reference to particular embodiment thereof, it will be understood by those skilled in the art that various changes in form and details may be effected therein without departing from the sprit and scope of the invention as defined by the appended claims.

This application claims priority from the Korean Patent Application Nos. 10-2000-0015206 (Mar. 24, 2000) and 10-2000-0055968 (Sep. 23, 2000), the contents of which are hereby incorporated by reference in their entirety, including the specification, drawings and claims.

What is claimed is:

1. A multi-channel quantitative control valve apparatus, comprising:
a multi-channel membrane valve that comprises two (2) or more the first control valve comprising an inlet 30, the first air flow passage 10, the first inner space 80, a liquid flow passage 44 which connects said first inner space and said inlet, a liquid flow passage 45 which connects said the first inner space and said the second control valve 2, and a membrane inserted at said first inner space, the second control valve 2 comprising a syringe connector 51, the second air flow passage 20, the second inner space 81, a liquid flow passage 46 that connects said second inner space and said syringe connector, a liquid flow passage 45 that connects said second inner space and said first control valve, and a membrane inserted in the second inner space, and the third control valve comprising an outlet 70, the third air flow passage 21, the third inner space 82, a liquid flow passage 48 that connects said third inner space and said outlet, said liquid flow passage 47 that connects said the third inner space and said syringes connector, and membrane inserted at the third inner space;
a syringe 50 which is connected to said syringe connectors 51 of said membrane valves; and
a stepping motor 53 which operates a piston 52 of said syringe 50.

2. The multi-channel quantitative control valve apparatus according to claim 1, further comprising a liquid flow connecting passage 92 that links liquid flow passages 45 with each other that connects the first inner spaces 80 and the second control valves 2 of each channel of the said membrane valve.

3. The multi-channel quantitative control valve apparatus according to claim 1, further comprising the second air flow connecting passage 90 that links the second air flow passages 20 with each other of each channel of said membrane valve.

4. The multi-channel quantitative control valve apparatus according to claim 1, further comprising the third air flow connecting passage 91 that links the third air flow passages 21 with each other of each channel of said membrane valve.
